(19) United States
(12) Patent Application Publication
(10) Pub. No.: US 2014/0268706 A1
(43) Pub. Date: Sep. 18, 2014

(54) ORNAMENTAL DEVICE HAVING LASER-ENGRAVED PATTERN

(71) Applicant: CHIN-SHENG YANG, Tainan City (TW)

(72) Inventor: CHIN-SHENG YANG, Tainan City (TW)

(21) Appl. No.: 13/831,592

(22) Filed: Mar. 15, 2013

(51) Int. Cl. F21V 3/04; F21L 4/00

(52) U.S. Cl. CPC F21V 3/0436; F21L 4/00
USPC 362/186

(57) ABSTRACT

The ornamental device contains the following components. A base member has a power element to provide electricity to the ornamental device. A lighting member on top of the base member electrically connected to the power element. A hollow, transparent, and spherical shell member made of a plastic material has a top through hole, a bottom opening, and a graphical pattern formed by laser engraving on a circumferential wall. The lighting member is housed inside the shell member which in turn is joined to the base member. A shade member is configured on the through hole of the shell member. By the light radiated from the lighting member through the shell member, the graphical pattern provides enriched and elevated visual and illumination effects.

### TECHNICAL FIELD OF THE INVENTION

The present invention is generally related to ornamental devices, and more particular to an ornamental device having a laser-engraved graphical pattern.

### DESCRIPTION OF THE PRIOR ART

In order to fulfill various desires of customers, today's products are required to provide multiple functions. Taking the household lamps as examples, their visual appearances are a vital buying decision in addition to their illumination function. Furthermore, the lamps are often required to have different shapes and styles so as to be compatible with the other furniture and to achieve a consistent interior design. Versatility is therefore a major focus of lamp manufacturers.

### SUMMARY OF THE INVENTION

Therefore, an ornamental device having a laser-engraved graphical pattern is provided herein. The ornamental device contains the following components.

A base member has a power element. The power element has at least a battery to provide electricity to the ornamental device.

A lighting member on top of the base member electrically connected to the power element.

A hollow, transparent, and spherical shell member made of a plastic material has a top through hole, a bottom opening, and a graphical pattern formed by laser engraving on a circumferential wall of the shell member. The lighting member is housed inside the shell member which in turn is joined to the base member.

A shade member is configured on the through hole of the shell member. By the light radiated from the lighting member through the shell member, the graphical pattern provides enriched and elevated visual and illumination effects.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a downward perspective diagram showing an ornamental device according to an embodiment of the present invention.

FIG. 2 is a perspective break-down diagram showing the various components of the ornamental device of FIG. 1.

FIG. 3 is a profile diagram showing the ornamental device of FIG. 1.

FIG. 4 is a sectional diagram showing the ornamental device of FIG. 1.

FIG. 5 is an upward perspective diagram showing the ornamental device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

As illustrated in FIGS. 1 to 5, an ornamental device according to an embodiment of the present invention mainly contains the following components.

A base member 1 contains a power element 11 having at least a battery to provide electricity to the ornamental device. The base member 1 has a socket 12 on a top side and a bottom cover 13 joined to a bottom side of the base member 1.

A lighting member 2 contains a circuit board 21 plugged into the socket 12 of the base member 1 so as to establish electrical contact with the battery. The circuit board 21 is electrically connected to at least a lighting element 22.

A hollow, transparent, and spherical shell member 3 is made of a plastic material. The shell member 3 has a top through hole 34, a bottom opening 31, and a graphical pattern 32 formed by laser engraving on the shell member 3's circumferential wall. The lighting member 2 is housed inside the shell member 3 which in turn is joined to the base member 1.

A shade member 4 has a ring-shaped plug 41 to a bottom side for fixing the shade member 4 to the through hole 34 of the shell member 3.

In the present embodiment, there are two multi-colored lighting elements 22 and the base member 1 further contains a switch 14 series-connected between the power element 11 and the circuit board 21 for turning on and off the lighting elements 22. A first lighting element 22 is configured on a top end of the circuit board 21 and is extended out of the shell member 3 through the through hole 34. The shade member 4 is hollow and shaped like candle flame, and the first lighting element 22 is housed in the shade member 4. The lighting member 2 further contains an integrated circuit 23 for controlling the color sequence and on/off timing of the lighting elements 22. A second lighting element 22 illuminates the graphical pattern 32 from inside the shell member 3 so as to produce a decorative ambient light.

The graphical pattern 32 can be formed on the internal or external surface of the circumferential wall of the shell member 3. The formation is achieved by laser-engraving a vacuum-plated or coated interior layer to hollow out the unwanted areas of the interior layer so that only the graphical pattern 32 is left. An additional color layer can be further coated on the interior layer so as to enhance the appearance of the graphical pattern 32. If the graphical pattern 32 is configured on the external surface of the shell member 3, the internal surface can be covered by a translucent decorative layer 33 made of transparent adhesive embedded with paillettes or glittery powders, or made of grit-blasted or matted transparent adhesive. The graphical pattern 32 therefore provides enriched and elevated visual and illumination effects.

The aforementioned laser engraving refers to the process of cutting the surface of an object by laser beams. Depending on the power and density of the laser beams, various effects can be achieved. Laser engraving can gasificate a coated or electroplated surface so as to reveal the material's original color.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An ornamental device having a laser-engrave graphical pattern, comprising:
a base member having a power element, the power element having at least a battery to provide electricity to the ornamental device;
a lighting member on top of the base member electrically connected to the power element;
a hollow, transparent, and spherical shell member made of a plastic material, the shell member having a top through hole, a bottom opening, and a graphical pattern formed by laser engraving on a circumferential wall of the shell member, where the lighting member is housed inside the shell member which in turn is joined to the base member; and
a shade member configured on the through hole of the shell member.

2. The ornamental device according to claim 1, wherein the base member further has a switch series-connected to the power element for turning on and off the lighting member.

3. The ornamental device according to claim 1, wherein the graphical pattern is configured on an internal surface of the circumferential wall of the shell member.

4. The ornamental device according to claim 1, wherein the graphical pattern is configured on an external surface of the circumferential wall of the shell member.

5. The ornamental device according to claim 4, wherein the internal surface of the circumferential wall of the shell member is covered by a translucent decorative layer.

6. The ornamental device according to claim 1, wherein the shade member has a ring-shaped plug for fixing the shade member to the through hole of the shell member.

7. The ornamental device according to claim 1, wherein the lighting member has a circuit board and at least a lighting element; and the circuit board is electrically connected to the power element and the lighting element.
